(19) United States
(12) Patent Application Publication
(10) Pub. No.: US 2007/0024657 A1
(43) Pub. Date: Feb. 1, 2007

(54) Method and apparatus for calibrating colour print engines

(76) Inventors: Nengsheng Allan Zhang, Singapore (SG); Winson Lan, Singapore (SG)

Correspondence Address: DICKSTEIN SHAPIRO LLP, 1177 AVENUE OF THE AMERICAS (6TH AVENUE), NEW YORK, NY, 10036-2714, US

(21) Appl. No.: 10/575,596

(22) PCT Filed: Oct. 13, 2003
(86) PCT No.: PCT/SG03/00245

§ 371 Date: Apr. 13, 2006

(51) Int. Cl. B41J 29/393

(52) U.S. Cl. 347/19

(57) ABSTRACT

A calibration method for print engines is disclosed herein. In a preferred embodiment, the method comprised the steps of: providing a calibration chart (101) having a first array of reference colours thereon; printing a separate test sheet (102) at step (301) from a said print engine; the test sheet (102) having a second array of test colours thereon, each test colour corresponding to one reference colour of the first array; arranging both sheets (101, 102) together; scanning the sheets (101, 102) at step (302) to capture a digital image of the reference and test colours; analysing the colour characteristics at step (303) to obtain the colour difference between corresponding pairs of reference and test colours; and compensating any colour difference at step (304) by automatically adjusting the printer in accordance with the colour difference.

### BACKGROUND AND FIELD OF THE INVENTION

This invention relates to calibration method and apparatus for colour print engines, more particular but not exclusively, using fuzzy logic to adjust the output of a colour print engine.

The term “print engine” is used broadly in this application to include colour laser copiers and printers, colour ink jet printers, colour dye transfer printers, colour photocopiers, colour digital offset printers and the like.

With the advance in technology for colour reproduction, the use of colour in imaging continues to grow at an ever-increasing pace. With the increased use of colour images, demand for high quality colour printing has also increased considerably. Print engines such as colour copiers, printers and professional press systems create colour images by combining base colorants such as pigments or dyes in response to image data. For example, conventional colour systems produce an image by combining cyan, magenta, yellow and black (CMYK) colorants. The same CMYK image data printed using different colour reproduction systems (or called print engines) can produce images which have different colour characteristics. This difference is due to different absorption spectra of the colorants, different amount (densities) of the colorants, and different mixing characteristics (trapping) of the colorants. The factors that may affect the colour characteristics include temperature, humidity, paper type, type of toner/ink, and application.

These are but some of the inherent problems relating to colour print:
“WYSIWYG”: What you see on the monitor is never what you get in CMYK prints.
Inconsistent colour: Colour output changes over time on a printer/copier.
Different colours: The same image printed on different printers may be visually different.
Colour confidence: After a printer is calibrated, the user is still unsure whether the “calibrated” output is actually what the user desires since there is usually no control over how the printer performs its calibration.
Knowledge and practice: Adjusting colour settings require experience, skill and knowledge.
Calibration: When does one calibrate printers and how should this be performed?

All the above problems are challenges for the colour printing industry and up to now it is still difficult to establish whether the colour output of a colour reproduction system necessarily achieves the desired or correct colour effect. It is often said that there is no printer that can reproduce colour perfectly. With the emergence of open publishing systems based on standard computing platform, colour communication between different input/output devices is getting more complex. The International Colour Consortium (ICC) was established in 1993, to develop common standards independent of the type of colour device. Examples of the standard proposed by the ICC is the device-independent colour profile specification based on CIE LAB or CIE XYZ colour space for transforming between different colour models used by different input/output devices to ensure reliable colour reproduction.

CIE LAB model is able to identify the difference of two colours by means of colour match in a well-defined colour space. However, the accuracy of colour match depends on the complexity of the colour transformation/masking equations. Higher the order of the polynomial for the colour transformation, the more accurate is the colour match. Thus, since the algorithms are complex, there is usually a need to make a compromise between the number of test colours and the cost of computation.

ICC also recommended a guideline for creating an ICC profile for printing systems. However, the difficulty is to generate a device dependent colour characteristic data required for such a profile to meet the increasing demand for high quality colour printing.

To overcome the above problems, there has been proposed numerous colour management methods for calibrating colour printing devices, such as the patent documents described below:

European patent No. EP 0,562,971 discloses a method and apparatus for adaptive colour characterising and calibrating colour document scanners, colour display units and colour printers using channel independent linear transfer function or calibration curves. A calibration target including a plurality of colour patches is used in the method which focuses on the transformation between CIE L*A*B* (or L*U*V*) and RGB spaces. However, since the transformation is based on CIE L*A*B* and RGB which are based on “additive colours”, it is complicated to apply this method to colour printers due to the inherent non-additive response of printing devices.

U.S. Pat. No. 5,537,516 discloses a method for calibrating a subject printer using a subject scanner for determining the state of the subject printer and using an object scanner and an object printer as reference. The same type of object scanner and printer are calibrated and their outputs saved as digital data to be supplied to users as references to compare with outputs of subject scanners and printers. The differences are used to calibrate the subject printers. In the case of calibrating a subject printer, a digital standard target is input to the subject printer. Output from the subject printer is then provided to a subject scanner, which has been calibrated prior to receiving the output. The output from the subject scanner is compared with the reference digital data provided to users and printer calibration curves are derived which are used to calibrate the subject printer. However, this method is limited to the specific type of object scanner and printer as the pre-determined reference digital data are not applicable to other types of scanners and printers. Furthermore, the accuracy of the colour output after calibration using this method relies on consistency of colour between subject and object scanners (and printers) and this is difficult to achieve.

U.S. Pat. No. 6,141,120 discloses a method for calibrating colorants of a colour copying and printing system using a scanner as a densitometer. To set up the scanner for this purpose, a scanner profile is obtained by scanning a standard gray scale test strip comprising a plurality of gray scale patches, each with known reference density values. The density values of the scanned test strip are compared with the known reference density values to obtain the scanner profile. Once the scanner profile is obtained, the scanner is ready to calibrate a printer. A calibration target used in the method comprises a plurality of single-colour-component colour patches printed using the printer to be calibrated. The calibration target is next scanned (which can be scanned simultaneously with the standard gray test strip above) and converted to an absolute density scale using the scanner profile. After conversion to absolute densities, the scanned calibration scale is compared to the originating test data to determine the printer profile which is used to calibrate the printer. Based on the colour patches printed after a colour calibration has been performed as above, it is still difficult to tell whether the desired colours are being printed or the printer is indeed calibrated since there is no direct comparison between the patches and the test strip as the latter is used to generate a mapping from RBG to absolute CMYK density. Moreover, there is a need to obtain the scanner profile in order to perform the calibration of the printing system.

U.S. Pat. No. 5,751,450 discloses a method and system for measuring colour difference. It provides a method for objective colour comparison by means of automatically and quantitatively measuring colour difference between a colour distribution of an object and a reference colour image using “colour distance” in a colour system. The colour distance is preferably based on Euclidean distance which is given by:
Distance=\sqrt{(iRef−iS)²+(hRef−hS)²+(sRef−sS)²}

Here, iRef is intensity of the reference pixel, and iS is intensity of the sample pixel, the h and s components are the hue and saturation quantities, respectively. However, the method is limited to machine vision system for colour recognition, colour filtering, and colour-based image segmentation and thus the method proposed therein is only concerned with determining whether there is a colour difference.

U.S. Pat. No. 5,218,555 discloses a method for judging or measuring colour difference using rules and fuzzy inference. The method is used for inspecting the colour printed on a textile fabric and similar to U.S. Pat. No. 5,751,450, the method is also based on Euclidean distance for measuring the colour difference.

In addition, in conventional colour printing and control, when the colour difference is known, it utilises manual off-line colour testing and manual colour adjustments by skilled technicians/engineers. This process is knowledge-intensive and time-consuming.

It is an object of the present invention to provide calibration method and apparatus for print engines which alleviates at least one of the disadvantages of the prior art and/or provides the public with a useful choice.

### SUMMARY OF THE INVENTION

In a first aspect of the invention, there is provided a method of calibrating a print engine based on a calibration chart having a first plurality of reference colours, the method comprising the steps of: i) printing a test sheet from the print engine; the test sheet having a second plurality of test colours thereon, each test colour corresponding to a reference colour; ii) digitising the reference and test colours; iii) calculating a colour difference between corresponding pairs of digitised reference and test colours; and iv) adjusting the print engine in accordance with the difference to reduce the colour difference between each colour pair.

An advantage of the described embodiment of the invention is that since the calibration chart can be pre-printed, a specific type of paper can thus be used and the quality and standard of the reference colours on the calibration chart can be assured and controlled. The test sheet, on the other hand, can be printed using paper used normally by the end user and thus the calibration would take into account effects of the normal printing paper. In addition, each test colour corresponds to a reference colour and thus a direct comparison can be made and each test colour can be adjusted to match its corresponding reference colour. For example, in a print engine based on CMYK colour model, selected combinations of colorants can be used to represent the entire gamut of the colour model. Thus, once the print engine is calibrated against these selected combinations, there is reasonable amount of confidence that the print engine can reproduce the colours in the entire gamut satisfactorily.

In addition, a further advantage is that there is no need to determine the absolute values of each colour for comparison with their reference absolute values that are predetermined, for example, the hue or saturation since the measurement is relative and thus it does not matter what is the actual value but what is important is the difference between the reference and test colours.

Preferably, the calibration chart includes openings formed therein which corresponds to the position of the second plurality of test colours, and the method further comprises the step of: arranging the calibration chart on the test sheet prior to the digitising step (ii).

Preferably, each reference or test colour is formed from a combination of one or more colour components. Alternatively, each reference or test colour is formed from a combination of two or more colour components.

The method may further comprise the steps of: obtaining pixel information representing each digitised test and/or reference colour; and computing each colour component's intensity at each pixel. The computed intensities may then be averaged to obtain a mean intensity of each colour component for each test and reference colour: and the difference in mean intensity calculated between corresponding pairs of test and reference colours. The calculated difference may then be used to represent the amount of colour difference between the test and reference colours.

Preferably, the colour difference is defined by a fuzzy variable which may be represented by:

$${d}_{i} = d ( {P}_{i}^{S} , {P}_{i}^{T} ) = \frac{1}{k} \times {\sum }_{x = 1}^{k} {d}^{x} ( {P}_{i}^{S} , {P}_{i}^{T} ) ;$$

where,

dᵢ is the colour difference between ith pair of corresponding reference colour Pᵢ^{S} and test colour Pᵢ^{T};

k is the number of colour components; and

d^{x} is the mean colour density difference between the ith pair of corresponding reference colour Pᵢ^{S} and test colour Pᵢ^{T} for x colour component.

The colour difference calculation may be based on CMYK, RGB or CIE L*A*B* colour model. Preferably, the method further comprises the step of calculating amount of noise present in each colour pair.

Preferably, the adjustment step is based on fuzzy inference. The adjustment may be performed automatically or manually. Further, the method may comprise the step of verifying the print engine's output prior to the adjustment step (iv). The verification step may provide a user interface to manually adjust the colour difference between corresponding pairs of test and reference colours.

In a second aspect of the invention, there is provided a method of calibrating a print engine, comprising the steps of: (i) capturing an image including a first plurality of reference colours and a second plurality of test colours printed by the print engine, each test colour corresponding to a reference colour; (ii) digitising the reference and test colours; (iii) using fuzzy functions to calculate a difference in colour between corresponding pairs of digitised reference and test colours; (iv) defining the difference as a fuzzy value; and (v) adjusting the print engine based on the fuzzy value to reduce the colour difference between each colour pair.

The use of fuzzy functions determines how the adjustment can be made for example, to increase or decrease the intensity of one of the colour components making up the test colour. There is also no need to take into account the profile of the image capturing device since the same device is used to capture the colour information for both test and reference, preferably, simultaneously and thus this minimise variance between the captured image of the test and reference colours.

Preferably, the reference colours are provided on a calibration chart and the test colours are provided on a separate test sheet prior to the digitising step (ii).

The use of fuzzy membership determines how the adjustment can be made for example, to increase or decrease the density of one of the colour components making up the test colour.

Typically, each reference or test colour is formed from a combination of one or more colour components.

Preferably, step (ii) further comprises the steps of: obtaining pixel information from the digital image; and computing density of each colour component at each pixel for each test and/or reference colour. Further, the method may comprise the steps of: averaging the computed densities to obtain a mean density of each colour component for each test and reference colour; and calculating the colour difference between corresponding pairs of test and reference colours based on respective mean densities.

Preferably, the colour difference is represented by a fuzzy variable , dᵢ, defined as

$${d}_{i} = d ( {P}_{i}^{S} , {P}_{i}^{T} ) = \frac{1}{k} \times {\sum }_{x = 1}^{k} {d}^{x} ( {P}_{i}^{S} , {P}_{i}^{T} ) ;$$

where, k is the number of colour components; and
d^{x} is the mean colour density difference between the ith pair of corresponding reference colour Pᵢ^{S} and test colour Pᵢ^{T} for x colour component.

The method may further comprise the step of deriving colour channels containing one colour component based on d^{x}. Preferably, the method also comprises the step of calculating a colour difference between colour channels.

The colour channel difference may be defined as a fuzzy variable, fdᵢ, wherein

$${fd}_{i} = fd ( {P}_{i}^{S} , {P}_{i}^{T} ) = \frac{1}{m} \times {\sum }_{x is a filtered channel} {fd}^{x} ( {P}_{i}^{S} , {P}_{i}^{T} )$$

where m is the number of filtered colour channels; and

fd^{x} is the mean colour density difference between the ith pair of corresponding reference colour Pᵢ^{S} and test colour Pᵢ^{T} for x colour component which is a filtered colour channel.

Preferably, the method may further comprise the step of calculating noise εᵢ which is defined by:
εᵢ=ε(Pᵢ^{S},Pᵢ^{T})=d(Pᵢ^{S},Pᵢ^{T})−fd(Pᵢ^{S},Pᵢ^{T})

In a third aspect of the present invention, there is provided a method of deriving an adjustment value for a print engine, the method comprising the steps of: (i) capturing an image including a first plurality of reference colours and a second plurality of test colours printed by the print engine, each test colour corresponding to a reference colour; (ii) digitising the reference and test colours; (iii) calculating a difference in colour between corresponding pairs of digitised reference and test colours; and (iv) providing the calculated colour difference for verification.

This allows a user to verify the colour difference before applying the adjustment value to the print engine. Preferably, a display is used for displaying the colour difference. The colour difference may be displayed in graphical form.

The method may further comprise the step of adjusting the print engine based on the calculated difference to reduce the colour difference between each colour pair. This may be controlled by the user whether to apply the calculated colour difference to adjust the print engine. Preferably, the adjustment step is performed before step (iv). Alternatively, the adjustment step may be performed after step (iv). In the former case, the method further comprising the steps of: printing a test sheet including the plurality of test colours from the adjusted print engine; and visually comparing the test colours against a plurality of reference colours provided on a calibration chart.

The present invention also includes calibration apparatus for performing the methods mentioned above.

### BRIEF DESCRIPTION OF THE DRAWINGS

An embodiment of the invention will now be described, by way of example, with reference to the accompanying drawings in which,

FIG. 1 shows a calibration chart, a test sheet and a composite sheet formed by combining the calibration chart and test sheet;

FIG. 2 illustrates block diagrams of an apparatus for calibrating the output of a print engine;

FIG. 3 shows the process steps for calibrating and adjusting a print engine according to the preferred embodiment of the present invention;

FIG. 4 shows a flow diagram of the colour data extraction step of FIG. 3;

FIG. 5 shows a method of locating reference points for the composite sheet to extract the colour data in the extraction step of FIG. 4;

FIG. 6 shows an example of a layout of an image profile;

FIGS. 7a and 7b show respectively examples of a default image profile and an actual image profile;

FIG. 8 shows the flow diagram for performing the step of “negative” colour comparison of FIG. 3;

FIG. 9 shows a class diagram related to colour characteristics;

FIGS. 10A and 10B show definitions of four fuzzy membership functions;

FIGS. 11A to 11D show the distribution of four base colorants in a colour patch;

FIG. 12 shows a block diagram of a fuzzy expert system in accordance with the present invention;

FIG. 13A is a graph showing the results of a negative colour comparison before adjustment and FIG. 13B shows the results after adjustment;

FIG. 14 shows a user interface for visual verification of the colour patches; and

FIG. 15 shows a user interface for visual verification of the graphs of FIGS. 13A and 13B.

### DETAILED DESCRIPTION OF THE PREFERRED EMBODIMENT

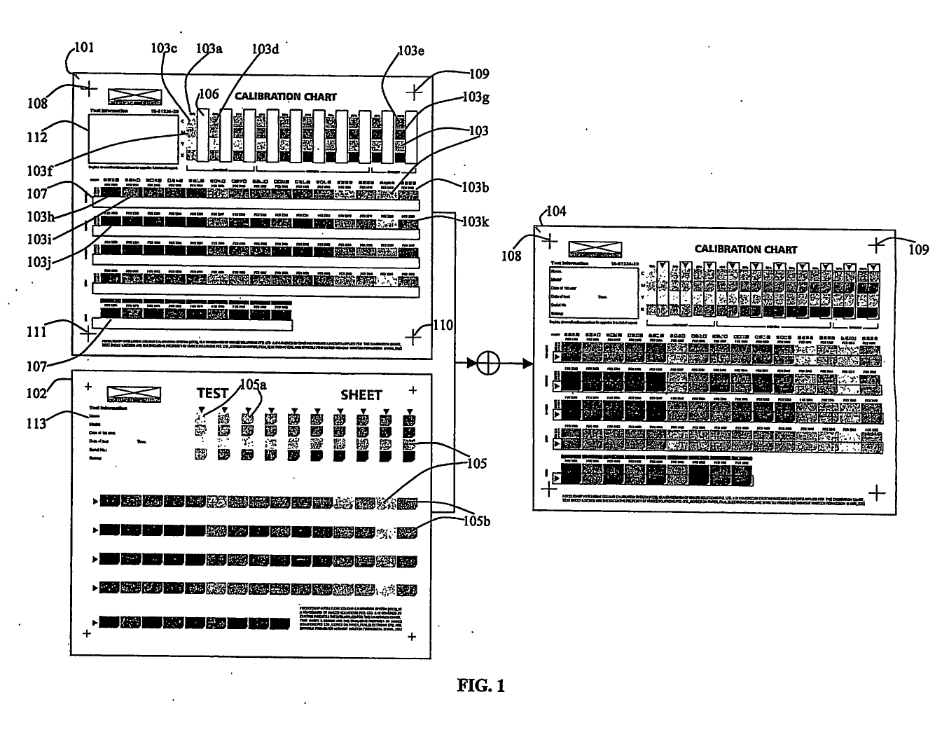

FIG. 1 shows a calibration chart 101 and a test sheet 102 which are improvements over those disclosed in patent No. U.S. Pat. No. 5,953,990, the contents of which are incorporated herein by reference. In U.S. Pat. No. 5,953,990, a specific type of paper must be used as the test sheet since both the images of the test sheet and master sheet are printed on the same paper for the calibration process. However, the actual paper being used for normal printing or copying is usually different from the specific type of paper used for the calibration and thus the colour characteristics of the “calibrated” print engine drift due to the paper difference.

In the present invention, a calibration chart 101 is a pre-printed chart of a calibration data file comprising Cyan (C), Magenta (M), Yellow (Y) and K (Black) base colorants. The data file is stored in a computer system as an image file such as TIFF or PDF format and pre-printed on a specific type of paper. As shown in FIG. 1, the printed calibration chart has an array of colour patches 103 arranged in columns 103a and rows 103b which are formed based on principles of another patent No. EP 0119836, the contents of which are incorporated herein by reference. Alternatively, the colour patches may be created based on Focoltone Colour System (FCS) by Focoltone which uses percentage of colorants C, M, Y and K to define each colour patch. For example, colour FCS1082 contains 0% of C, 100% of M, 100% of Y, and 25% of K. Thus, each colour patch 103 is a combination of the four base colorants to create different colours for each patch. In this embodiment, there are one hundred and nine colour patches 103 on the calibration chart 101 based on the FCS. However, it should be apparent that the number of colour patches 103 can be changed according to requirements.

The colour patches 103 in each column 103a have a single colorant, either C, M, Y or K but with different intensities to create different colour effects. For example, the first colour patch 103c at the first column is created using 10% of cyan and no other base colorants. The intensity is increased along the same horizontal row with the next patch 103d formed from 20% of cyan and so on until the 10^{th} patch 103e formed using 100% of cyan. Going down the first column, similarly, the 11^{th} colour patch 103f is formed from 10% of magenta and so on until the 20^{th} patch 103g which is formed from 100% of magenta. The same methodology is used to create the different colour effects for yellow and black colorants.

Coming to the five rows 103b in the calibration chart, the intensity of each colorant is fixed but each colorant is turned ON or OFF to create the different colour effects along the entire row. For example, the 41^{st} patch 103h is created with 15% cyan, 30% magenta, 50% yellow and 25% black. However, for the 42^{nd} patch 103i, the black colorant is turned off and thus this colour patch 103i is formed from 15% cyan, 30% magenta, 50% yellow and 0% of black. These create the fifteen different colour patches along the same row with some colour patches having two colorants being turned off.

The same principle is used for the subsequent rows to create different colour effects for each colour patch 103, for example, the row of colour patches from the 56^{th} patch 103j to 70^{th} patch 103k is formed from permutations of colorants comprising 55% cyan, 65% magenta, 25% yellow and 35% black.

Ideally, the reference colours should include each and every colour in the CMYK gamut. However, this is technically difficult and quite impossible. Thus, the reference colour patches (and test colour patches) are selected to represent the entire colour gamut such that if the test colours of the print engine is calibrated to match these selected reference colours, there is reasonable amount of confidence that the print engine will print the entire colour gamut satisfactorily.

The calibration chart 101 has a plurality of die-cut rectangular openings 106, 107 arranged beside each column 103a and row 103b. For each column 103a of “single-component” colour patches 103 on the calibration chart 101, a vertical opening 106 is formed beside each column 103a. Similarly, for the colour patches arranged in rows 103b, there is an elongate opening 107 arranged below each row.

The test sheet 102 is printed on demand by the print engine under calibration and this has an array of colour patches 105 arranged as columns 105a and rows 105b similar to the layout of the calibration chart 101 but the array is offset from the array of colour patches 103 in the calibration chart 101 such that when the calibration chart is placed and aligned on the test sheet, the array of colour patches 105 on the test sheet 102 can be seen through respective openings 106,107. When the calibration chart 101 and the test sheet 102 are so arranged, a composite sheet 104 is formed as shown in FIG. 1. Preferably, the test sheet 102 allows a user to input test information 113 for example customer name, model of the printer or copier under calibration and date of the calibration. In this case, the calibration chart also provides for a corresponding rectangular opening 113 so that the test information can be observed through the opening 113 when the calibration chart is overlaid on top of the test sheet 102.

As mentioned earlier, the calibration chart 101 is pre-printed on a specific paper using the CMYK standard and thus the chart 101 can be provided to the end user or service provider as a standard colour target, preferably together with the printer or copier. The test sheet 102 is a printout of calibration data which can be provided on a diskette or downloaded and this can be printed on paper which is used for normal reproduction or printing by the user. Since the calibration chart is provided separately, there is no need to specify the type of paper for the test sheet and thus the calibration is performed with reference to the actual type of paper which is used by the user.

By performing the calibration based on a calibration chart 101, it is possible to create a common standard for print engines. In this application, colour standardisation includes ensuring that colour is being processed consistently throughout the entire colour reproduction process.

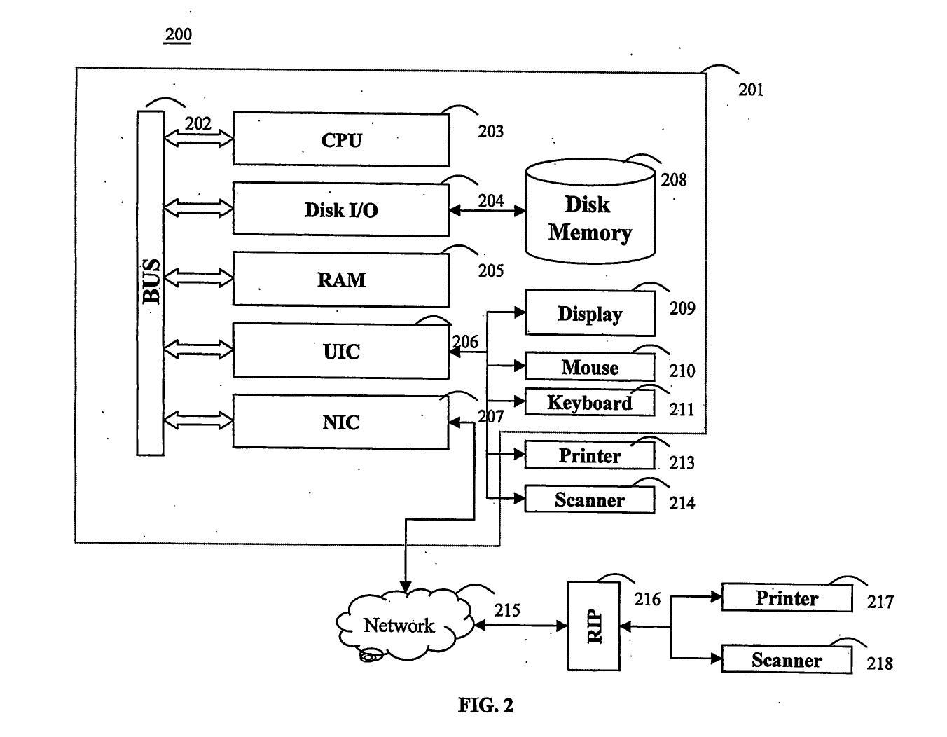

With reference to FIG. 2, there is illustrated a functional block diagram of the apparatus 200 comprising a personal computer 201 having a central processing unit 203, a disk I/O card 204, an internal memory RAM 205, a user interface component (UIC) 206 and a network interface card (NIC) 207. A data bus 202 is used for transfer of data between these components. In addition, non-volatile memory 208 such as a hard disk, CD-ROM or floppy drive is provided for storing software and data via the disk I/O card 204. Input/Output devices such as a display 209, mouse 210, keyboard 211 are provided for a user to interact with the computer 201. A scanner 214 and a printer 213 for calibration may be connected locally to the personal computer 201 via UIC 206. Alternatively, or in addition, the computer may communicate remotely with a network printer 217 and scanner 218, preferably via a Raster Image Processor (RIP) 216.

Once the printer 213,217 under calibration is set-up above, the apparatus 200 is ready to perform colour standardization.

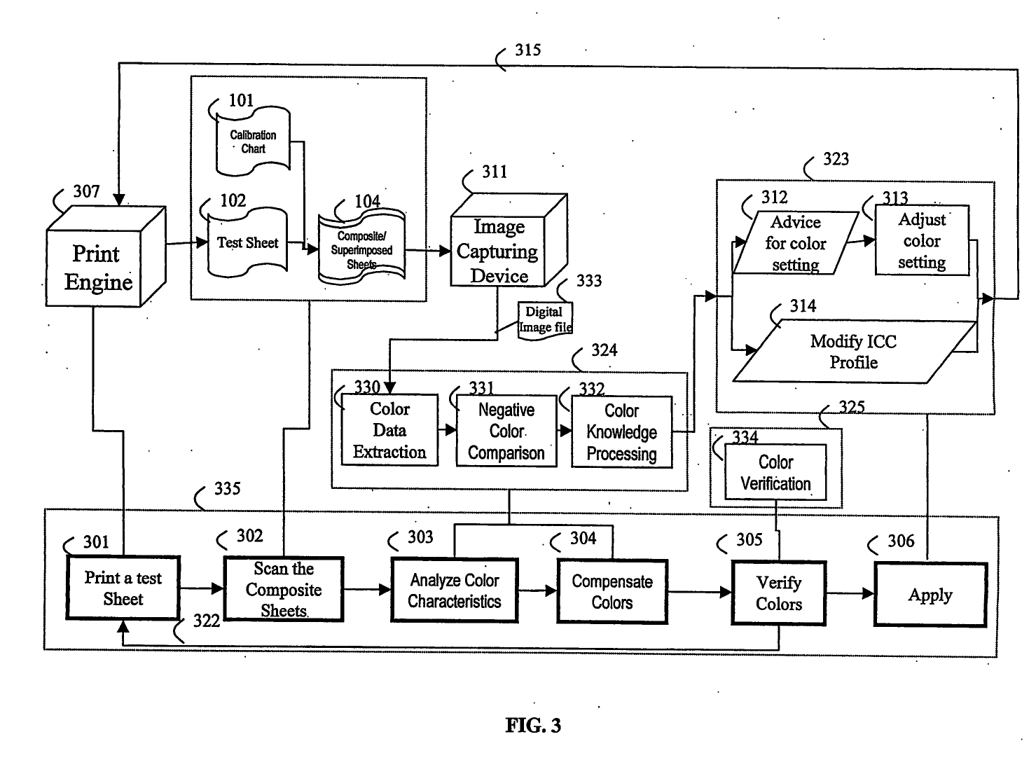

FIG. 3 shows the various steps of performing colour print standardisation according to a preferred embodiment of the present invention. To begin the calibration process, the user selects a print engine to calibrate which can be a local printer 213 or a network printer 217 and also the ICC profile (if any) for that printer, and at step 301, a test sheet 102 is printed on a sheet of paper by the printer to be calibrated. In this embodiment, a network print engine 217 such as a Canon CLC 1150 copier, is used as an example. The image capturing device 311 is a scanner integral to the Canon brand CLC 1150 copier. The output of this step is a printed test sheet 102. The test sheet 102 and the calibration chart 101 are then overlaid with the chart 101 being placed on top of the test sheet 102 to form the composite 104.

At step 302, the composite sheet 104 is next scanned by the scanner 311 described above. The output from the scanner 311 is a digital image file 333 in CMYK colour model, preferably in TIFF format. Since the composite sheet comprising the reference and the test colours is scanned by the same image capturing device, there is no need to take into account the profile of the image capturing device.

After the image of the composite sheet 104 is obtained, at step 303 the colour characteristic of the image is analysed next. There are three different stages for this step, the first of which is extraction of the colour data 330.

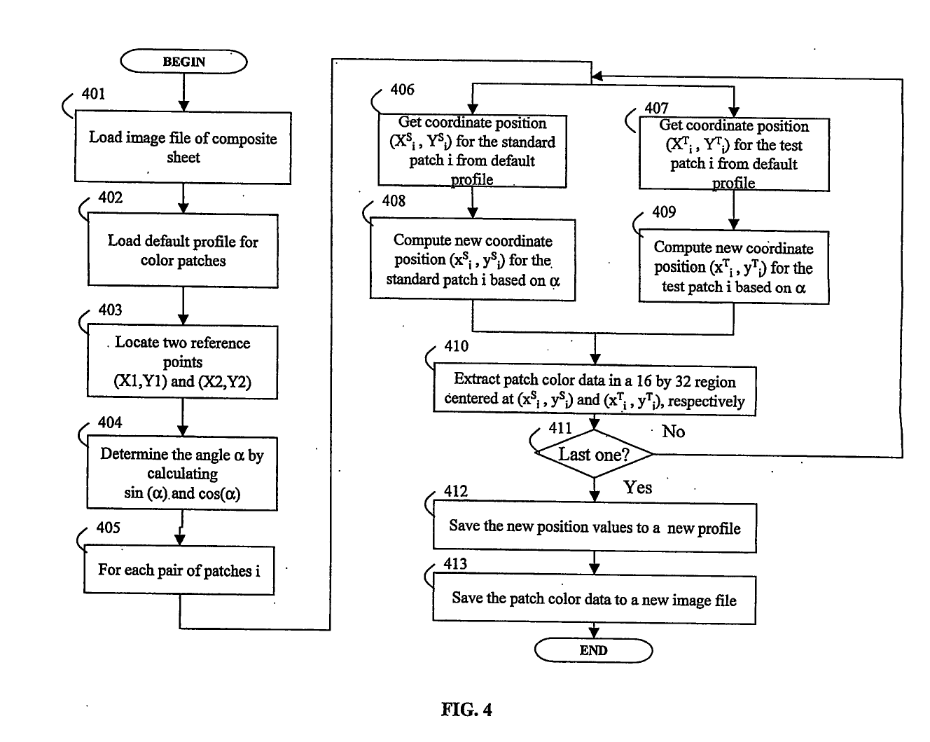

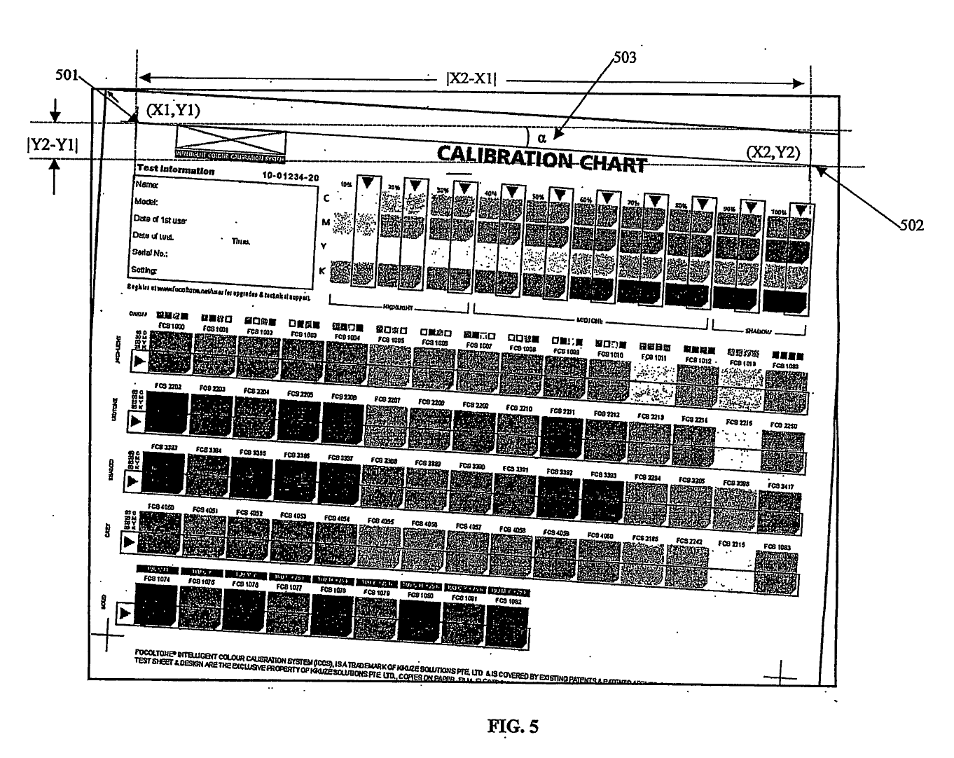

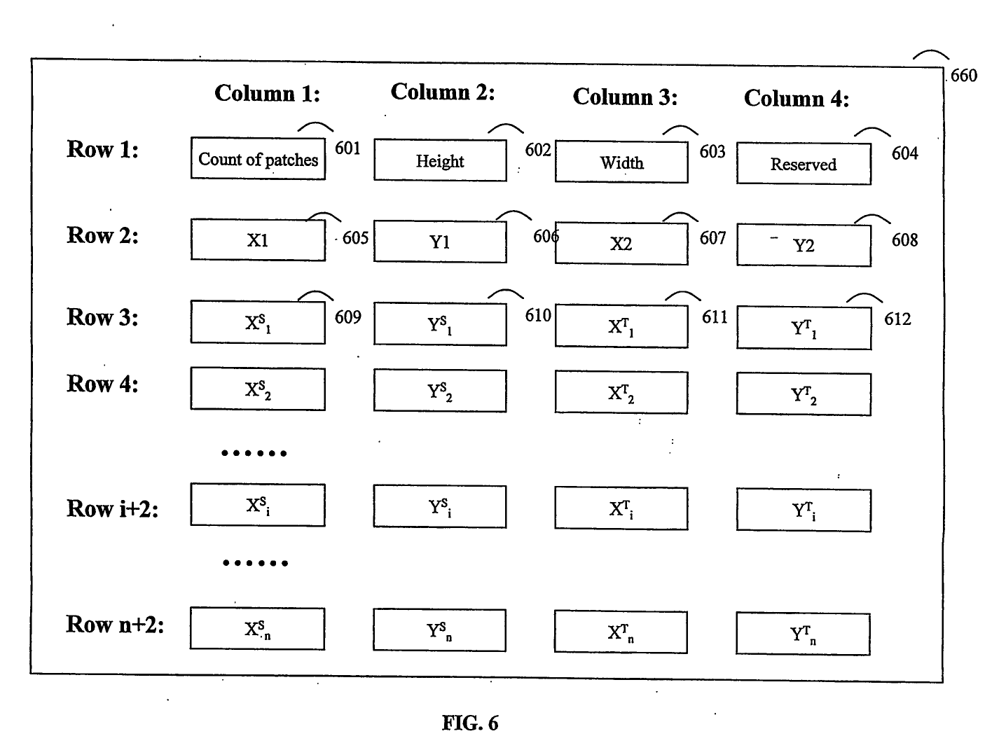

With reference to FIG. 4, there is illustrated a flow diagram of the colour data extraction step 330. Firstly, at step 401, the digital file 333 of the scanned composite image is loaded into the computer memory 205 for processing. Next, at step 402 a default profile 660 is loaded and FIG. 6 shows the format of the profile 660. The default image profile 660 provides default information about the scanned image 333 and default positions of the colour patches 103. To facilitate the image capturing process, two fiducial marks 108 and 109 (see FIG. 1) are provided on the calibration chart 101 and since the calibration chart 101 is placed on top of the test sheet 102, the scanned image of the composite sheet 104 also shows the fiducial marks 108,109. At step. 403, these two fiducial marks are located using normal vision recognition techniques and their central points (X1, Y1) 501 and (X2,Y2) 502 (see FIG. 5) determined.

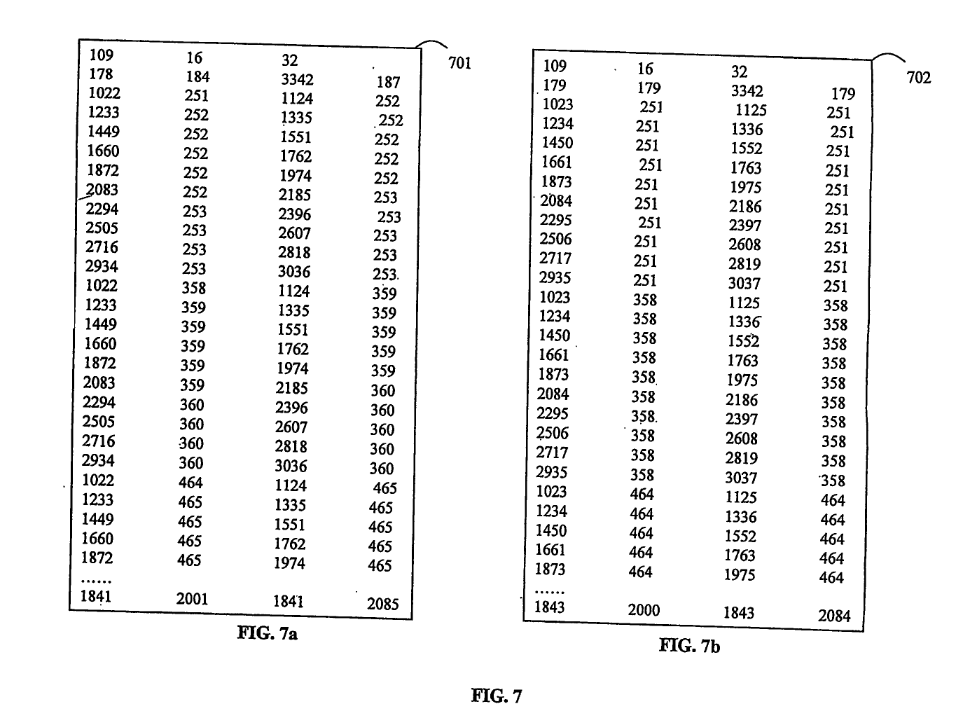

FIG. 6 illustrates a typical layout of the information structure of the image profile 660 which has a matrix of cells arranged as four columns and n+2 rows. Cell 601 (row one, column one) records the number of colour patches 103 on the calibration chart 101 (in this embodiment, there are one hundred and nine patches). Cells 602 and 603 store the dimensions (height and width) of the * boundary defining each patch from which the colour pixel data is to be extracted, and the dimensions are used for every colour patch 103, 105 on the calibration chart 101 and test sheet 102. In row two, cells 605 and 606 store respectively the default coordinates X1,Y1 for the first fiducial point 108, and cells 607 and 608 similarly store the coordinates X2,Y2 respectively for the second fiducial point 109. From row 3 onwards, the first two columns 609,610 store the reference default locations for the standard colour patches 103 of the composite sheet 104 (i.e. patches provided on the calibration chart), and the last two columns 611,612, the reference default locations for the test colour patches 105 (i.e. those provided on the test sheet 102). For example, cells 609,610 store the position values or coordinates (X₁^{S},Y₁^{S}) for the first standard colour patch, and cells 611,612 store the position values(X₁^{T},Y₁^{T}) for the first test colour patch. FIG. 7a depicts a default image profile 701 with the default coordinates of the standard and test patches.

In an ideal situation when there is no misalignment, the positions of colour patches of the scanned composite sheet would correspond to the X,Y coordinates in the image profile but practically, this is unlikely. Thus, as shown in FIG. 5, the image of the composite sheet 104 has some misalignment due to the scanning process. This problem may be solved manually using an image processing software like Adobe Photoshop to rotate, crop or adjust the image. In the preferred embodiment of the present invention, this is performed automatically to determine the actual coordinate positions of each colour patch 103,105 to begin the colour data extraction.

As shown in FIG. 5, to determine the positions of the colour patches 103,105 in the image, the deviation angle α needs to be calculated at step 404. This angle can be determined using the two reference points (X1, Y1) 501 and (X2, Y2) 502 using the following formula:

$$α = arcsin ( \frac{Y 2 - Y 1}{\sqrt{{( X 2 - X 1 )}^{2} + {( Y 2 - Y 1 )}^{2}}} ) \qquad ( 1 )$$

where, arcsin is reverse sine function. It should be apparent that other trigonometric functions may be used to calculate the deviation angle depending on the misalignment.

Having obtained the deviation angle, the new coordinate positions can be determined at steps 405 to 409 by using the formulas as follow:

$$\begin{matrix}{x}_{i}^{s} = {X}_{i}^{S} \times \frac{Y 2 - Y 1}{\sqrt{{( X 2 - X 1 )}^{2} + {( Y 2 - Y 1 )}^{2}}} - {Y}_{i}^{S} \times \frac{X 2 - X 1}{\sqrt{{( X 2 - X 1 )}^{2} + {( Y 2 - Y 1 )}^{2}}} & ( 2 ) \\ {y}_{i}^{s} = {Y}_{i}^{S} \times \frac{Y 2 - Y 1}{\sqrt{{( X 2 - X 1 )}^{2} + {( Y 2 - Y 1 )}^{2}}} + {X}_{i}^{S} \times \frac{X 2 - X 1}{\sqrt{{( X 2 - X 1 )}^{2} + {( Y 2 - Y 1 )}^{2}}} & ( 3 ) \\ {x}_{i}^{T} = {X}_{i}^{T} \times \frac{Y 2 - Y 1}{\sqrt{{( X 2 - X 1 )}^{2} + {( Y 2 - Y 1 )}^{2}}} - {Y}_{i}^{T} \times \frac{X 2 - X 1}{\sqrt{{( X 2 - X 1 )}^{2} + {( Y 2 - Y 1 )}^{2}}} & ( 4 ) \\ {y}_{i}^{T} = {Y}_{i}^{T} \times \frac{Y 2 - Y 1}{\sqrt{{( X 2 - X 1 )}^{2} + {( Y 2 - Y 1 )}^{2}}} + {X}_{i}^{T} \times \frac{X 2 - X 1}{\sqrt{{( X 2 - X 1 )}^{2} + {( Y 2 - Y 1 )}^{2}}} & ( 5 )\end{matrix}$$

where, (Xᵢ^{S},Yᵢ^{S}) and (Xᵢ^{T},Yᵢ^{T})are respectively the coordinate points for the i^{th} pair of colour patches Pᵢ^{S} (a standard colour patch) and Pᵢ^{T} (a test colour patch) in the default profile, and (xᵢ^{S},yᵢ^{S}) and (xᵢ^{T},yᵢ^{T})are the new coordinate points for the same pair of colour patches 103,105 in the new image profile.

At step 410, the colour pixel data can be extracted based on the size of the patch defined in the image profile 660 (for example 16×32 as in FIG. 7a) and the coordinate positions (xᵢ^{S},yᵢ^{S}) and (xᵢ^{T},yᵢ^{T})for the loaded image file. For example, given x₁^{S}=1023, y₁^{S}=251,x₁^{T}=1125 and y₁^{T}=251 (in pixels), the colour pixel data represented using CMYK can be extracted from two rectangular region of size of 16×32 pixels centred at (1023,251) and (1125,251) from the loaded image file to represent a first pair of reference and test colour. Steps 406 to 410 are repeated until the colour data for all the patches 103,105 are obtained and at step 412, the generated position information is saved to a new image profile 702, such as that shown in FIG. 7b.

Finally, the colour pixel data is saved to a new data file, preferably, as raw binary format, at step 413.

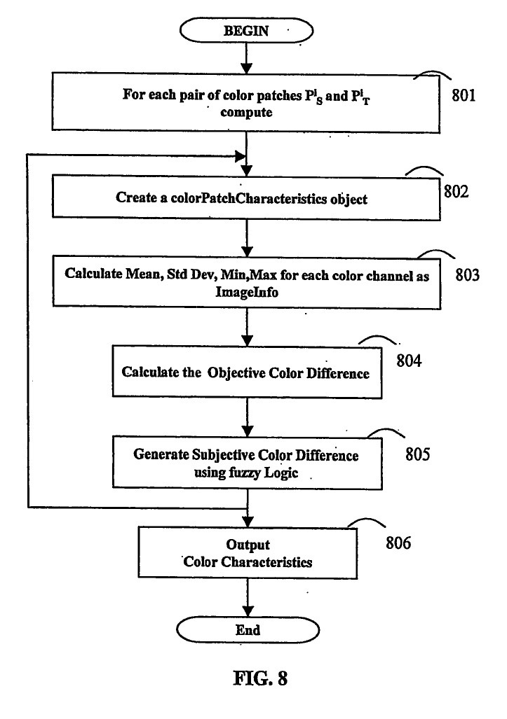

Once the colour data is extracted, the next step is to compare the data obtained between the standard colour patches and the test patches on the composite sheet. This is illustrated at step 331 of FIG. 3 and FIG. 8 illustrates detailed steps of performing “negative” colour comparison 331 for capturing the colour characteristics of the colour patches.

Instead of measuring the similarity of colours, the negative colour comparison measures the difference in colours and in the preferred embodiment “subjective” and “objective” comparison are used.

Subjective colour comparison mainly relies on the human eye to visually compare one colour with another colour being used as a reference. It is a fact that the human eye cannot measure colour accurately but can compare them. To elaborate, two individuals looking at a single colour will see the colour differently. These two individuals looking at two different colours will still see each of them differently but they will see the difference between the two colours with the same accuracy. Thus, in colour comparison, the nature of the colour is not important but what is important is the difference between the two colours which appears consistent between two persons. Based on this, subjective colour comparison is typically used in visual color calibration.

Objective color comparison, on the other hand, requires the use of a measuring device to measure the colorants or intensity of a colour and compare with another reference colour. Devices for measuring the colour for objective comparison include spectrophotometer, calorimeter, densitometer and scanner.

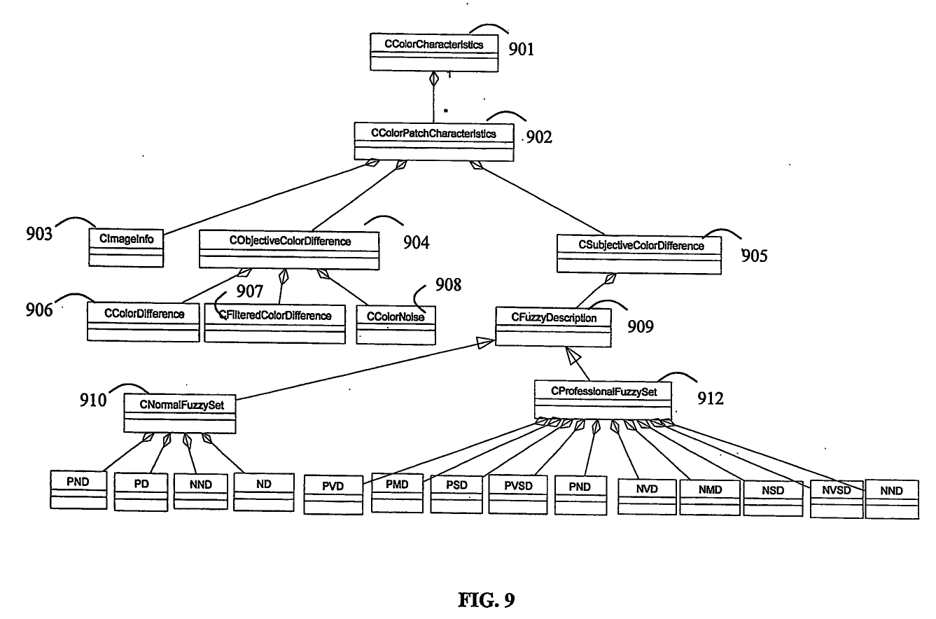

The colour data extraction step 330 outputs the colour data of each pair of colour patch Pᵢ^{S} and Pᵢ^{T} (i.e. a standard and a test colour patch) to the negative comparison step 331 and this step is shown in detail in FIG. 8. To begin the colour comparison, at step 802, a new object of type of ColorPatchCharacteristics 902 (see FIG. 9) is created for each pair of colour patches Pᵢ^{S} and Pᵢ^{T} which is associated with three other objects, namely CImageInfo 903, CObjectiveColourDifference 904 and CSubjectiveColourDifference 905. This is illustrated in FIG. 9 which is a UML (United Modeling Language) class diagram representing the colour characteristics.

At step 803, for each colour patch, the intensity distribution of each colorant C,M,Y,K forming a pixel is calculated in terms of mean, standard deviation, minimum colorant and maximum colorant. The values of these parameters are stored in the object CImageInfo 903 representing information for the pixel data of the colour patches extracted from the scanned image file.

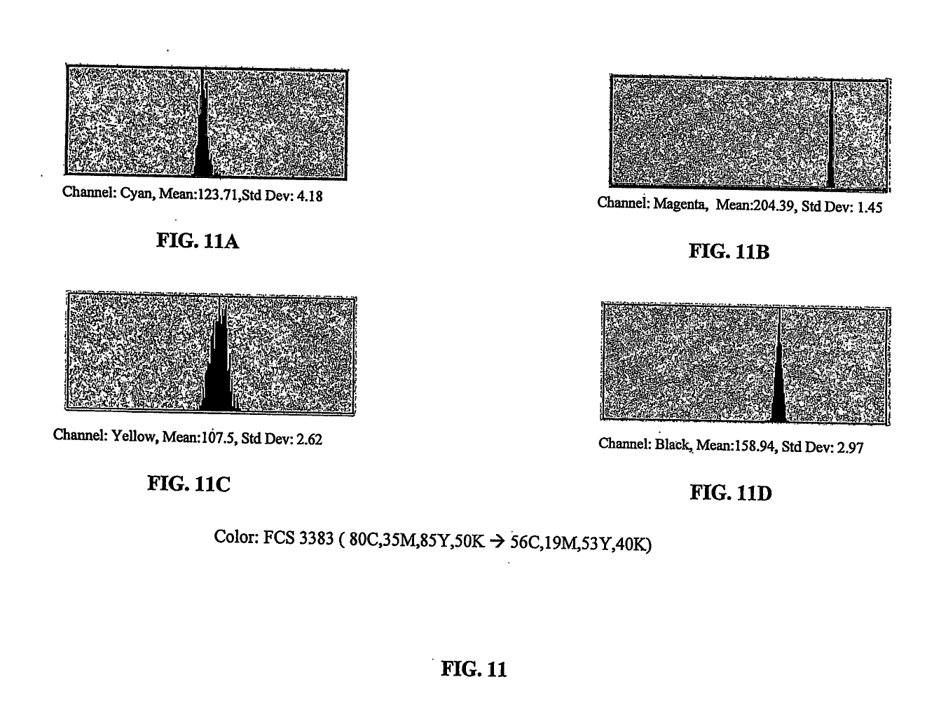

An example of the mean and standard deviation of a colour patch based on Focoltone Colour System (FCS) 3383 is shown in FIGS. 11A to 11D. Based on the distribution of the colorants forming each colour patch, it is reasonable to s use the mean values of the colorants to represent the overall intensity of each colour patch. At step 804, the objective colour differences can be computed using the following formulas for each colour channel C,M,Y and K:
d^{C}(Pᵢ^{S},Pᵢ^{T})=ω× (̅P̅ᵢ̅^̅{̅S̅}̅(̅C̅)̅− P̅ᵢ̅^̅{̅T̅}̅(̅C̅)̅)̅ (6)
d^{M}(Pᵢ^{S},Pᵢ^{T})=ω× (̅P̅ᵢ̅^̅{̅S̅}̅(̅M̅)̅− P̅ᵢ̅^̅{̅T̅}̅(̅M̅)̅)̅ (7)
d^{Y}(Pᵢ^{S},Pᵢ^{T})=ω× (̅P̅ᵢ̅^̅{̅S̅}̅(̅Y̅)̅− P̅ᵢ̅^̅{̅T̅}̅(̅Y̅)̅)̅ (8)
d^{K}(Pᵢ^{S},Pᵢ^{T})=ω× (̅P̅ᵢ̅^̅{̅S̅}̅(̅K̅)̅− P̅ᵢ̅^̅{̅T̅}̅(̅K̅)̅)̅ (9)
where P̅ᵢ̅^̅{̅S̅}̅(̅x̅)̅ and P̅ᵢ̅^̅{̅T̅}̅(̅x̅)̅ represent the mean of colorants of standard colour patch Pᵢ^{S} and test colour patch Pᵢ^{T}, respectively; ω is a constant related to the depth of colour represented in a pixel, in this invention, ω=100/255 as 32 bits is used for each pixel; and xε{C,M,Y,K}.

At this stage, the difference in intensity, if any, for each colorant C,M,Y,K for each pair of test and standard colour patch is known but the colour difference does not consider whether there is noise which may affect the measurement.

To take noise factor into consideration, it is important to know whether a colour patch 103,105 is actually without one or more of the base colorants. For example, if a colour patch is supposed to represent colour FCS1001 (corresponding to the 42^{nd} colour patch 103i of FIG. 1) and there is a certain amount of black colour detected based on the objective measurement, the colour of the test patch should appear greyish which is incorrect since FCS 1001 should not have any composition of black colour. In order to represent this characteristic, a filtered colour channel for the colour patch is defined. For any colour channel x, it is a filtered channel for the colour patch if its colorant is not zero in the colour represented by the colour patch. The filtered colour difference is defined as follow:

$$\begin{matrix}{fd}^{C} ( {P}_{i}^{S} , {P}_{i}^{T} ) = \{ \begin{matrix}{d}^{C} ( {P}_{i}^{S} , {P}_{i}^{T} ) & if C is a filtered color channel ; \\ 0 & else\end{matrix} & ( 10 ) \\ {fd}^{M} ( {P}_{i}^{S} , {P}_{i}^{T} ) = \{ \begin{matrix}{d}^{M} ( {P}_{i}^{S} , {P}_{i}^{T} ) & if M is a filtered color channel ; \\ 0 & else\end{matrix} & ( 11 ) \\ {fd}^{Y} ( {P}_{i}^{S} , {P}_{i}^{T} ) = \{ \begin{matrix}{d}^{Y} ( {P}_{i}^{S} , {P}_{i}^{T} ) & if Y is a filtered color channel ; \\ 0 & else\end{matrix} & ( 12 ) \\ {fd}^{K} ( {P}_{i}^{S} , {P}_{i}^{T} ) = \{ \begin{matrix}{d}^{K} ( {P}_{i}^{S} , {P}_{i}^{T} ) & if K is a filtered color channel ; \\ 0 & else\end{matrix} & ( 13 )\end{matrix}$$

As mentioned earlier, since the ideal percentage density of each colorant is known with black colorant supposed to be 0% for FCS 1001, it is possible to determine whether there is noise present by comparing the filtered colour difference and the colour difference obtained earlier.

The colour difference for the colour patches Pᵢ^{S} and Pᵢ^{T} in equations (6) to (9) and the filtered channels in equations (10) to (13) can be summarised as follows:

$$\begin{matrix}{d}_{i} = d ( {P}_{i}^{S} , {P}_{i}^{T} ) = \frac{1}{4} \times {\sum }_{x = C , M , Y , K} {d}^{x} ( {P}_{i}^{S} , {P}_{i}^{T} ) & ( 14 ) \\ {fd}_{i} = fd ( {P}_{i}^{S} , {P}_{i}^{T} ) = \frac{1}{m} \times {\sum }_{x ∈ \{ C , M , Y , K \}} {fd}^{x} ( {P}_{i}^{S} , {P}_{i}^{T} ) & ( 15 )\end{matrix}$$

where m is the number of filtered colour channels. The noise can be defined as fuzzy variable εᵢ defined as:
εᵢ=ε(Pᵢ^{S},Pᵢ^{T})=d(Pᵢ^{S},Pᵢ^{T})−fd(Pᵢ^{S},Pᵢ^{T}) (16)

The calculated values of the colour difference is then stored in the CObjectiveColorDifference 904 as a subset object called CColorDifference 906 and the colour differences from the filtered channels are stored in another subset object called CFilteredColorDifference 907. Specifically, Object CColorDifference 906 includes d^{c}(Pᵢ^{S},Pᵢ^{T}), d^{M}(Pᵢ^{S},Pᵢ^{T}), d^{Y}(Pᵢ^{S},Pᵢ^{T}), d^{K}(Pᵢ^{S},Pᵢ^{T}) and dᵢ(Pᵢ^{S},Pᵢ^{T}) whereas object CFilteredColorDifference 907 includes fd^{c}(Pᵢ^{S},Pᵢ^{T}), fd^{M}(Pᵢ^{S},Pᵢ^{T}), fd^{Y}(Pᵢ^{S},Pᵢ^{T}), fd^{K}(Pᵢ^{S},Pᵢ^{T}) and fdᵢ(Pᵢ^{S},Pᵢ^{T}).

The noise obtained based on equation (16) is stored in object CColorNoise 908 which is another subset of CObjectiveColorDifference 904.

The formula (6)˜(16) for determining colour difference is independent of the colour model of the print engine or the image capturing device since the formula can be applied to CMYK model as well as any other colour models such as RGB, CIE XYZ, CIE Lab, etc. In general, let k be the number of colour channels, the formula (14)˜(16) can be generalized as follows:

$$\begin{matrix}{d}_{i} = d ( {P}_{i}^{S} , {P}_{i}^{T} ) = \frac{1}{k} \times {\sum }_{x = 1}^{k} {d}^{x} ( {P}_{i}^{S} , {P}_{i}^{T} ) & ( 17 ) \\ {fd}_{i} = fd ( {P}_{i}^{S} , {P}_{i}^{T} ) = \frac{1}{m} \times {\sum }_{x is a filtered channel} {fd}^{x} ( {P}_{i}^{S} , {P}_{i}^{T} ) & ( 18 )\end{matrix}$$

where m is the number of filtered colour channels. The noise can be defined as
εᵢ=ε(Pᵢ^{S},Pᵢ^{T})=d(Pᵢ^{S},Pᵢ^{T})−fd(Pᵢ^{S},Pᵢ^{T}) (19)

Having obtained the colour difference based on objective measurements, at step 805, the difference in the colour measurements are “measured subjectively” using fuzzy rules and a fuzzy set for normal user level is defined by the following fuzzy values:

| Fuzzy Value | Meaning |
|---|---|
| PND | Positive No Different |
| PD | Positive Different |
| NND | Negative No Different |
| ND | Negative Different |

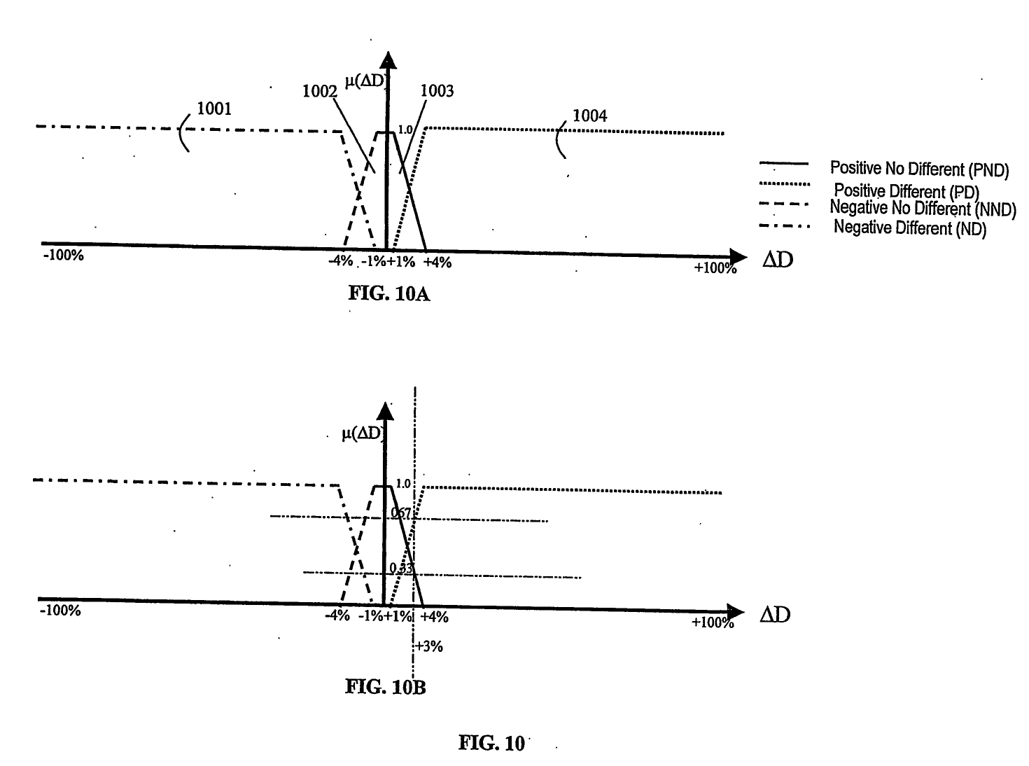

In this embodiment, the image file is saved as CMYK colour mode and eight bits per channel. Therefore, the captured colour measurement for each channel is in the range from 0 to 255. The measurement is then divided by 255 and converted into a value of form of percentage so that the range of difference of colour ΔD is ranged from −100% to +100%. FIG. 10A shows four fuzzy membership functions μ(ΔD). Region 1001,1002,1003 and 1004 represent fuzzy membership function Negative Different (ND), Negative No Different (NND), Positive No Different (PND) and Positive Different (PD), respectively. These fuzzy membership function can be also described using mathematical formulas as follows:

$$\begin{matrix}PND ( Δ D ) = \{ \begin{matrix}0 & Δ D < 0 \% \\ 1 & 0 ⇐ Δ D ⇐ 1 \% \\ ( 4 \% - Δ D ) \times \frac{1}{4 \% - 1 \%} & 1 \% < Δ D < 4 \% \\ 0 & Δ D >= 4 \%\end{matrix} & ( 20 ) \\ PD ( Δ D ) = \{ \begin{matrix}0 & Δ D < 1 \% \\ ( Δ D - 1 \% ) \times \frac{1}{4 \% - 1 \%} & 1 \% ⇐ Δ D ⇐ 4 \% \\ 1 & Δ D > 4 \%\end{matrix} & ( 21 ) \\ NND ( Δ D ) = \{ \begin{matrix}0 & Δ D < 0 \% \\ 1 & - 1 \% ⇐ Δ D ⇐ 0 \% \\ ( - 4 \% - Δ D ) \times \frac{1}{- 4 \% + 1 \%} & - 4 \% < Δ D < - 1 \% \\ 0 & Δ D < - 4 \%\end{matrix} & ( 22 ) \\ ND ( Δ D ) = \{ \begin{matrix}0 & Δ D > - 1 \% \\ ( Δ D + 1 \% ) \times \frac{1}{- 4 \% + 1 \%} & - 4 \% ⇐ Δ D ⇐ - 1 \% \\ 1 & Δ D < - 4 \%\end{matrix} & ( 23 )\end{matrix}$$

Based on the above fuzzy membership functions, the subjective colour different can be generated in terms of maximum of their values. For example, if the measurements of colour difference value is +3%, as shown in FIG. 10B, the outputs of fuzzy membership functions for PND, PD, NND, and ND are 0.33, 0.67, 0, and 0, respectively. Therefore, PD whose measurement value is highest is assigned to the object CFuzzyDescription and fuzzy inference is used to adjust the colorants accordingly as further elaborated below.

For the professional level, the fuzzy set is defined as follows:

| Fuzzy Value | Meaning |
|---|---|
| PND | Positive No Different |
| PVSD | Positive Very Slight Different |
| PSD | Positive Slight Different |
| PMD | Positive Moderate Different |
| PVD | Positive Very Different |
| NND | Negative No Different |
| NVSD | Negative Very Slight Different |
| NSD | Negative Slight Different |
| NMD | Negative Moderate Different |
| NVD | Negative Very Different |

The above fuzzy sets are depicted in the class diagram of FIG. 9 which forms a subset object CFuzzyDescription 909 under CSubjectiveColorDifference 905. As shown, the CFuzzyDescription object 909 includes a CNormalFuzzySet 910 (for normal user level) and CProfessionalFuzzySet 912 (for professional level). As mentioned earlier, the Normal Fuzzy Set 910 comprises fuzzy values: PND, PD, NND, and ND and the Professional Fuzzy Set 912 includes PND, PVSD, PSD, PMD, PVD, NND, NVSD, NSD, NMD and NVD.

When the difference measurements are each assigned a fuzzy value, this is output at step 806 and the fuzzy values are provided to the knowledge processing step 332 of FIG. 3.

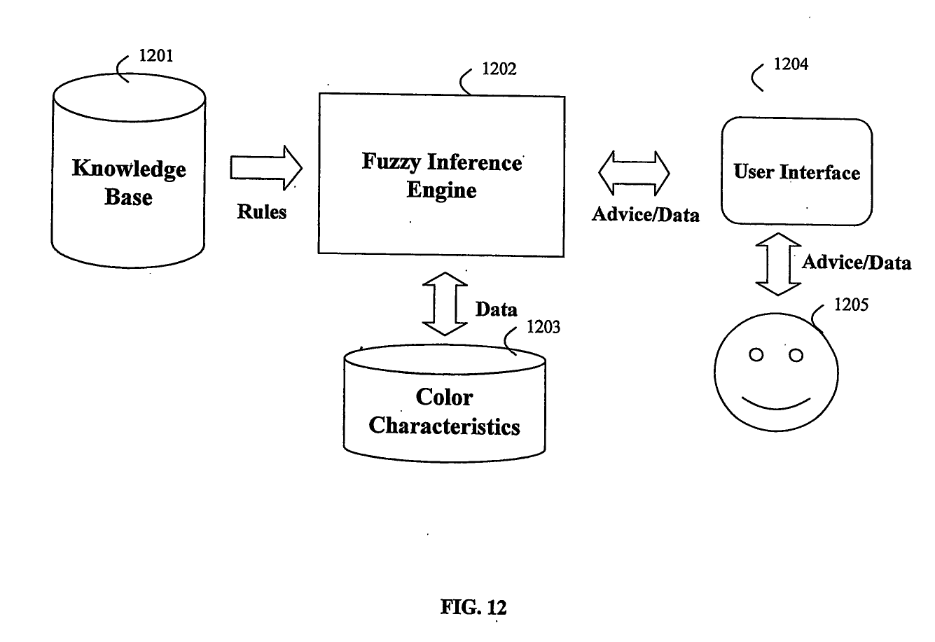

FIG. 12 illustrates the knowledge processing step in greater detail which is preferably performed by artificial intelligence such as an expert system. Generally, the expert system is a computer program dedicated to solving problems and giving advice within a specialised area of knowledge and a good system can match the performance of a human specialist. The basic components of an expert system are a knowledge database 1201 and a fuzzy inference engine 1202. The information in the database 1201 is obtained by interviewing people who are experts in the area concerned. The interviewer, or knowledge engineer, organises the information obtained from the experts into a collection of rules, typically of “if-then” structure. and the inference engine enables the expert system to draw deductions from the rules in the knowledge database 1201. An example of a fuzzy rule is: “If d^{C} is NSD then reduce C a little”.

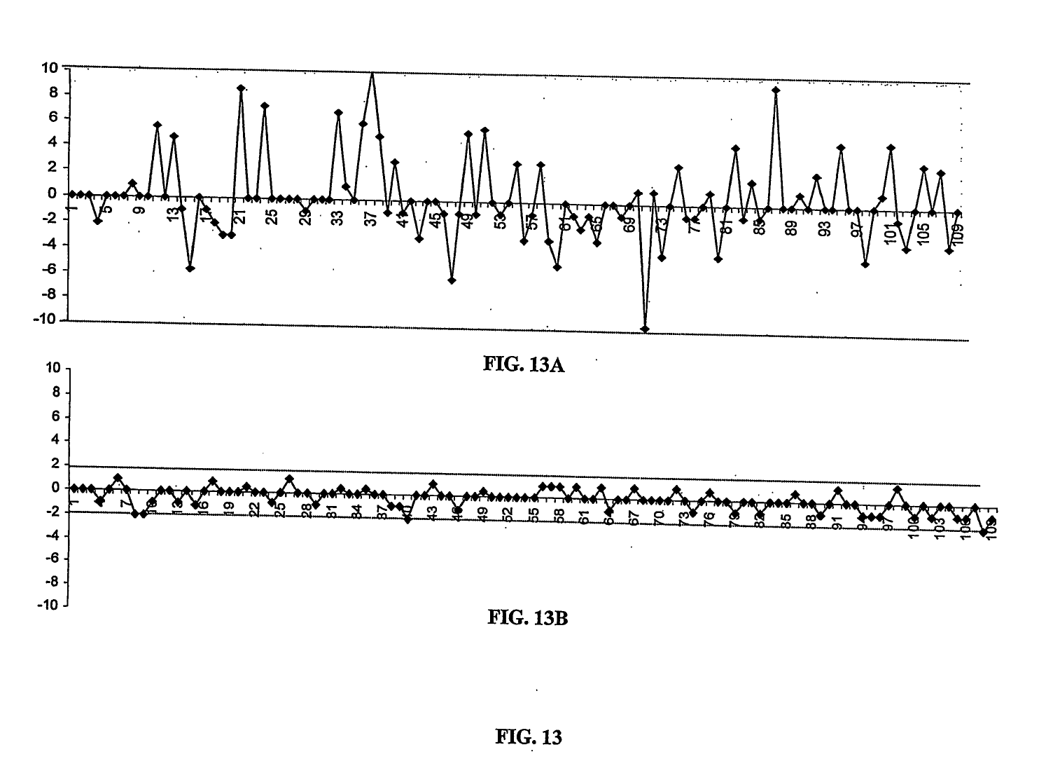

In this case, the input for the fuzzy expert system is the colour characteristics data 1203 from the Negative Colour Comparison step 331 (see FIG. 3) and the control strategy is described in FIG. 13. The colour characteristics data 1203 refers to the information being associated with the object CColorCharacteristics and its related sub-objects illustrated in FIG. 9.

With reference to FIG. 13, there is illustrated a graph chart for the negative colour comparison in accordance with the present invention. For each pair of colour patch Pᵢ^{S} and Pᵢ^{T}, i=1 . . . n, the overall colour difference is defined as follow:

$$\begin{matrix}\vert d \vert = {Max}_{i = 1}^{n} \vert ( {d}_{i} ) \vert & ( 24 ) \\ \vert fd \vert = {Max}_{i = 1}^{n} \vert ( {fd}_{i} ) \vert & ( 25 ) \\ \vert ɛ \vert = {Max}_{i = 1}^{n} \vert ( {ɛ}_{i} ) \vert & ( 26 )\end{matrix}$$

Formula (24)˜(26) are used as criteria for inference. FIG. 13A shows the overall colour difference is in the range from −10% to +10% as determined by the objective colour difference step 804 (of FIG. 8). FIG. 13B, on the other hand, shows what would be the overall colour difference if applied to a printer and the figure shows that the colour difference will be reduced within ±2% after fuzzy inference based on the fuzzy values of each colour patch. Thus, in this way, the variance of the printed colours is controlled to within an acceptable level.

The output of the colour knowledge processing step 332 (i.e. also the output of the compensation step 304) is next applied to the printer at step 306. Steps 312 to 314 show the application step 306 in greater detail. As illustrated, there are two methods for adjusting the colour output of the print engine: with ICC profile or without ICC profile. If the print engine supports ICC profile, the colour adjustment can be performed by modifying the ICC profile 314 which is simpler. Otherwise, the adjustment can also be changing colour settings 313 with input 312 being provided by the colour knowledge processing step 332.

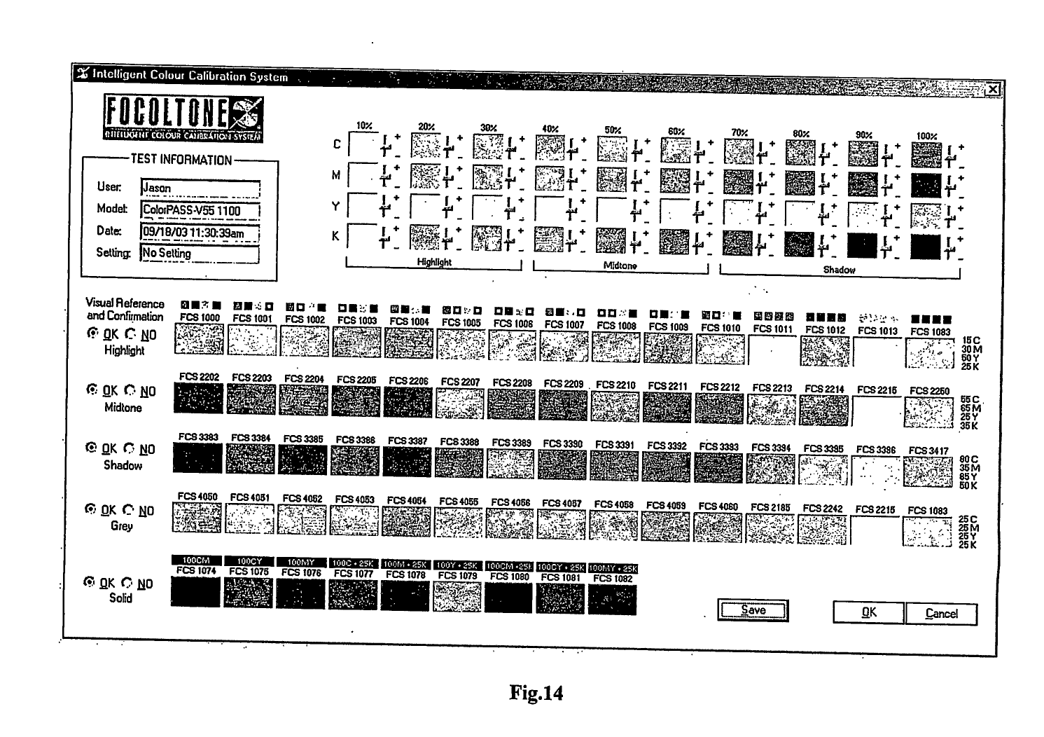

As illustrated in FIG. 3 at step 305, although the colour measurement and adjustment can be performed automatically without human intervention, the preferred embodiment also provides for a verification step before the adjustment data or settings are applied to the print engine. Preferably, this takes the form of a user interface 1401 which displays each of the test colour patches after the adjustment such as that shown in FIG. 14. The user can verify whether the computed result of the adjustment is in accordance with what the user wants and if not, the interface provides input control means for the user to manually adjust the colour intensities of the colorants accordingly. Since we are concern with the comparison of two colours, if the two colours appear satisfactory visually on the display, it should also be acceptable to the naked eye when the colour settings are applied to the print engine for printing on paper.

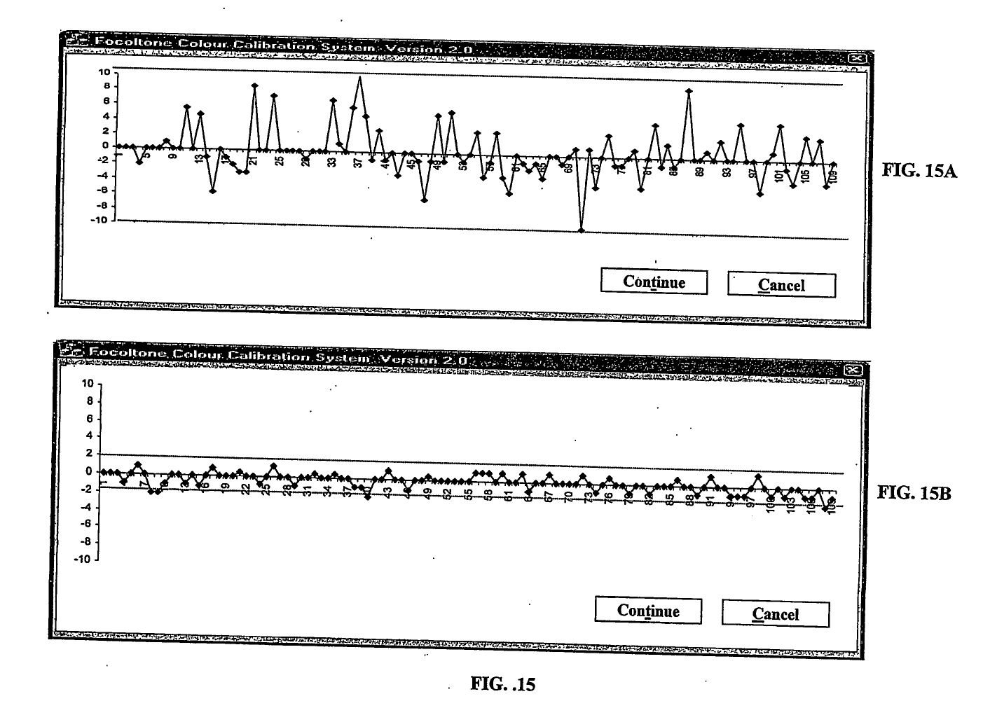

In addition, the interface also displays the results of the colour patch measurement before the adjustment and after the adjustment in graphical form as shown respectively in FIGS. 15A and 15B, which is an alternative way for the user to verify the printing output before he applies the colour settings to the printer.

After applying the settings, the user can simply print another test page to compare the result with the calibration chart to see the improvement in the colour effects or alternatively, he can print a colour picture to see the results. In a further alternative, the user can use the user interface to verify the colour outputs again or to perform manual adjustment.

The described embodiment should not be construed as limitative. For example, although the preferred embodiment uses CMYK as the colour model when measuring the colour intensity of a colour patch, other colour models such as RGB, CIELAB can similarly be used.

Two or more fiducial marks 110,111 instead of just two fiducial marks 108, 109 may be included which can be used to determine more accurately the actual positions of each colour patch.

Having now fully described the invention, it should be apparent to one of ordinary skill in the art that many modifications can be made hereto without departing from the scope as claimed.

1. A method of calibrating a print engine based on a calibration chart having a first plurality of reference colours, the method comprising the steps of
i) printing a test sheet from the print engine; the test sheet having a second plurality of test colours thereon, each test colour corresponding to a reference colour;
ii) digitising the reference and test colours;
iii) calculating a colour difference between corresponding pairs of digitised reference and test colours; and
iv) adjusting the print engine in accordance with the difference to reduce the colour difference between each colour pair, wherein the calibration chart includes openings formed therein, the openings corresponding to the positions of the second plurality of test colours, and the method further comprises the step of:
arranging the calibration chart on the test sheet prior to step (ii).

2. The method according to claim 1, wherein each reference or test colour is formed from a combination of one or more colour components.

3. The method according to claim 1, wherein each reference or test colour is formed from a combination of two or more colour components.

4. The method according to claim 2, wherein step (ii) further comprises the steps of:
obtaining pixel information representing each digitised test and/or reference colour; and
computing each colour component's intensity at each pixel.

5. The method according to claim 4, further comprising the step of:
averaging the computed intensities to obtain a mean intensity of each colour component for each test and reference colour; and
calculating the difference in mean intensity between corresponding pairs of test and reference colours, the calculated difference being the amount of colour difference between the test and reference colours.

6. The method according to claim 5, wherein the colour difference is defined by a fuzzy variable.

7. The method according to claim 6, wherein the fuzzy variable is represented by:
$${d}_{i} = d ( {P}_{i}^{S} , {P}_{i}^{T} ) = \frac{1}{k} ⨯ {\sum }_{x = 1}^{k} {d}^{x} ( {P}_{i}^{S} , {P}_{i}^{T} ) ;$$
where,
dᵢ is the colour difference between ith pair of corresponding reference colour Pᵢ^{S} and test colour Pᵢ^{T} ;
k is the number of colour components; and
d^{x} is the mean colour density difference between the ith pair of corresponding reference colour Pᵢ^{S} and test colour Pᵢ^{T} for x colour component.

8. The method according to claim 7, further comprising the step of calculating amount of noise present in each colour pair.

9. The method according to claim 1, wherein the colour difference calculation is based on CMYK colour model.

10. The method according to claim 1, wherein the colour difference calculation is based on RGB colour model.

11. The method according to claim 1, wherein the colour difference calculation is based on CIEL*A*B*.

12. The method according to claim 1, wherein the adjusting step is based on fuzzy inference.

13. The method according to claim 12, wherein the adjustment is automatic.

14. The method according to claim 1, further comprising the step of verifying the print engine's output prior to the adjustment step (iv).

15. The method according to claim 14, wherein the verification step provides a user interface to manually adjust the colour difference between corresponding pairs of test and reference colours.

16. A method of calibrating a print engine, comprising the steps of:
(i) capturing an image including a first plurality of reference colours and a second plurality of test colours printed by the print engine, each test colour corresponding to a reference colour;
(ii) digitising the reference and test colours;
(iii) using fuzzy functions to calculate a difference in colour between corresponding pairs of digitised reference and test colours;
(iv) defining the difference as a fuzzy value; and
(v) adjusting the print engine based on the fuzzy value to reduce the colour difference between each colour pair.

17. The method according to claim 16, wherein the reference colours are provided on a calibration chart and the test colours are provided on a separate test sheet prior to the image capture of step (i).

18. The method according to claim 16, wherein each reference or test colour is formed from a combination of one or more colour components.

19. The method according to claim 18, wherein step (ii) further comprises the steps of:
obtaining pixel information from the digital image; and
computing density of each colour component at each pixel for each test and/or reference colour.

20. The method according to claim 19, further comprising the steps of:
averaging the computed densities to obtain a mean density of each colour component for each test and reference colour; and
calculating the colour difference between corresponding pairs of test and reference colours based on respective mean densities.

21. The method according to claim 20, wherein the colour difference is represented by a fuzzy variable, dᵢ, defined as:
$${d}_{i} = d ( {P}_{i}^{S} , {P}_{i}^{T} ) = \frac{1}{k} ⨯ {\sum }_{x = 1}^{k} {d}^{x} ( {P}_{i}^{s} , {P}_{i}^{T} ) ;$$
where,
k is the number of colour components; and
d^{x} is the mean colour density difference between the ith pair of corresponding reference colour Pᵢ^{S} and test colour Pᵢ^{T} for x colour component.

22. The method according to claim 21, further comprising the step of deriving colour channels containing one colour component based on d^{x}.

23. The method according to claim 22, further comprising the step of calculating a colour difference between colour channels.

24. The method according to claim 23, wherein the colour channel difference is defined as a fuzzy variable, fdᵢ, where
$${fd}_{i} = fd ( {P}_{i}^{S} , {P}_{i}^{T} ) = \frac{1}{m} ⨯ {\sum }_{x is a filtered channel} {fd}^{x} ( {P}_{i}^{S} , {P}_{i}^{T} )$$
where m is the number of filtered colour channels; and
fd^{x} is the mean colour density difference between the ith pair of corresponding reference colour Pᵢ^{S} and test colour Pᵢ^{T} for x colour component which is a filtered colour channel.

25. The method according to claim 24, further comprising the step of calculating noise εᵢ which is defined by:
εᵢ=ε(Pᵢ^{S},Pᵢ^{T})=d(Pᵢ^{S},Pᵢ^{T})−fd(Pᵢ^{S},Pᵢ^{T})

26. The method according to claim 16, further comprising the step of verifying the print engine's output prior to the adjustment step (v).

27. The method according to claim 16, further comprising the step of: detecting the position of each digitised reference and test colour prior to the calculation step (iii).

28. The method according to claim 16, further comprising the step of detecting reference marks in the captured image prior to the digitising step (ii).

29. The method according to claim 28, further comprising the step of comparing the position of the reference marks with default position values of the reference marks;
calculating the difference; and
locating the positions of each reference and test colour in the captured image to perform the digitisation step.

30. A method of deriving an adjustment value for a print engine, the method comprising the steps of:
(i) capturing an image including a first plurality of reference colours and a second plurality of test colours printed by the print engine, each test colour corresponding to a reference colour;
(ii) digitising the reference and test colours;
(iii) calculating a difference in colour between corresponding pairs of digitised reference and test colours; and
(iv) providing the calculated colour difference for verification.

31. The method according to claim 30, wherein step (iv) further comprises the step of displaying the colour difference.

32. The method according to claim 31, wherein the colour difference is displayed in graphical form.

33. The method according to claim 30, further comprising the step of adjusting the print engine based on the calculated difference to reduce the colour difference between each colour pair.

34. The method according to claim 33, wherein the adjustment step is performed before step (iv).

35. The method according to claim 33, wherein the adjustment step is performed after step (iv).

36. The method according to claim 34, further comprising the steps of:
printing a test sheet including the plurality of test colours from the adjusted print engine; and
visually comparing the test colours against a plurality of reference colours provided on a calibration chart.

37. Apparatus for calibrating a print engine based on a calibration chart having openings formed therein and a first plurality of reference colours, the apparatus comprising:
i) a print engine arranged to print a test sheet having a second plurality of test colours, each test colour corresponding to a reference colour and the positions of the second plurality of test colours corresponding to the openings of the calibration chart when the chart is arranged on the test sheet;
ii) means for digitising the reference and test colours;
iii) processing means for calculating a colour difference between corresponding pairs of digitised reference and test colours; and
iv) control means for adjusting the print engine in accordance with the difference to reduce the colour difference between each colour pair.

38. Apparatus for calibrating a print engine comprising:
(i) an image capturing device arranged to capture an image including a first plurality of reference colours and a second plurality of test colours printed by the print engine, each test colour corresponding to a reference colour;
ii) means for digitising the reference and test colours;
(iii) processing means for calculating a difference in colour between corresponding pairs of digitised reference and test colours using fuzzy functions;
(iv) processing means for defining the difference as a fuzzy value; and
(v) control means for adjusting the print engine based on the fuzzy value to reduce the colour difference between each colour pair.

39. Apparatus for deriving an adjustment value for a print engine comprising:
(i) an image capturing device arranged to capture an image including a first plurality of reference colours and a second plurality of test colours printed by the print engine, each test colour corresponding to a reference colour;
ii) means for digitising the reference and test colours;
(iii) processing means for calculating a difference in colour between corresponding pairs of digitised reference and test colours; and
(iv) verification means for checking the calculated colour difference.

40. The apparatus according to claim 39, further comprising a display.

41. The apparatus according to claim 39, further comprising control means for adjusting the print engine based on the calculated difference to reduce the colour difference between each colour pair.

42. The apparatus according to claim 41, further comprising input devices to control the control means.
